(19) United States
(12) Patent Application Publication
(10) Pub. No.: US 2024/0297823 A1
(43) Pub. Date: Sep. 5, 2024

(54) INFRASTRUCTURE SYSTEM AND COMMUNICATION METHOD

(71) Applicant: NEC CORPORATION, Tokyo (JP)

(72) Inventor: Toshiaki TAKAHASHI, Tokyo (JP)

(73) Assignee: NEC CORPORATION, Minato-ku, Tokyo (JP)

(21) Appl. No.: 18/278,460

(22) PCT Filed: Mar. 26, 2021
(86) PCT No.: PCT/JP2021/013104

§ 371 Date: Aug. 23, 2023

(51) Int. Cl. H04L 41/0895; H04L 45/586; H04L 45/745

(52) U.S. Cl. CPC H04L 41/0895; H04L 45/586; H04L 45/745

(57) ABSTRACT

To provide an infrastructure system and a communication method capable of realizing network separation by a novel method in an operating environment using a container. An infrastructure system (1) includes a VM (2) in which a resource for executing a container including a plurality of virtual NICs is implemented and which includes a plurality of virtual NICs connected to different logical networks; and a controller (3) configured to control so that a communication path in which each of a plurality of the virtual NICs of the VM is connected to any one of the virtual NICs of the container is configured.

### TECHNICAL FIELD

The present disclosure relates to an infrastructure system and a communication method.

### BACKGROUND ART

A container is known as a virtual operating environment of software. For example, Patent Literature 1 discloses that a processing unit provides a business service of a virtualized network function for a user terminal by using a container.

### CITATION LIST

### Patent Literature

Patent Literature 1: Published Japanese Translation of PCT International Publication for Patent Application, No. 2019-519180

### SUMMARY OF INVENTION

### Technical Problem

The service provision having high scalability and flexibility by containers is beginning to be widely used mainly in the field of Web services, centering on CaaS (Container as a Service) infrastructure software called Kubernetes. However, as the application area thereof, an area for providing a service on a best effort basis has been common. However, in recent years, the communication capacity has increased even in a high-quality service, and there has been a use case that requires scalability and flexibility by container implementation. In this type of use case, there is a demand for performance management by separating networks for each use, but there is a problem that this demand cannot be met due to the configuration in which the CaaS infrastructure uses only one network.

Multus-CNI, which is a type of container network interface (CNI), provides a function of dividing a network of containers, but in this function, it is assumed that a newly added network is managed outside the CaaS infrastructure. For this reason, the adoption of this technology has been considered to lead to a decrease in scalability and flexibility.

Therefore, one of the objects to be achieved by the example embodiments disclosed in the present specification is to provide an infrastructure system and a communication method capable of realizing network separation by a novel method in an operating environment using a container.

### Solution to Problem

An infrastructure system according to a first aspect of the present disclosure includes:
a virtual machine (VM) in which a resource for executing a container including a plurality of virtual network interface cards (NIC) is implemented and which includes a plurality of virtual NICs connected to different logical networks: and
a controller configured to control so that a communication path in which each of a plurality of the virtual NICs of the VM is connected to any one of the virtual NICs of the container is configured.

A communication method according to a second aspect of the present disclosure includes the steps of:
having a VM including a plurality of virtual NICs connected to different logical networks execute a container including a plurality of virtual NICs: and
having a controller control so that a communication path in which each of a plurality of the virtual NICs of the VM is connected to any one of the virtual NICs of the container is configured.

### Advantageous Effects of Invention

According to the present disclosure, an infrastructure system and a communication method capable of realizing network separation by a novel method in an operating environment using a container can be provided.

### BRIEF DESCRIPTION OF DRAWINGS

FIG. 1 is a block diagram illustrating an example of a configuration of an infrastructure system according to an outline of an example embodiment.

FIG. 2 is a block diagram illustrating a configuration of an infrastructure system according to a comparative example.

FIG. 3 is a block diagram illustrating an example of a configuration of the infrastructure system according to the example embodiment.

FIG. 4 is a schematic diagram illustrating a logical network.

FIG. 5 is a diagram illustrating a flow of communication with respect to a container from the outside in the infrastructure system according to the comparative example.

FIG. 6 is a diagram illustrating a flow of communication with respect to a container from the outside in the infrastructure system according to the example embodiment.

FIG. 7 is a diagram illustrating a flow of communication from a container to the outside in the infrastructure system according to the comparative example.

FIG. 8 is a table illustrating an example of information in which a destination subnet and a logical network are associated with each other.

FIG. 9 is a table illustrating an example of a routing table set by a controller at the time of activating a container.

FIG. 10 is a diagram illustrating a flow of communication from a container to the outside in the infrastructure system according to the example embodiment.

FIG. 11 is a block diagram illustrating an example of a configuration of a computer.

### EXAMPLE EMBODIMENT

### Outline of Example Embodiments

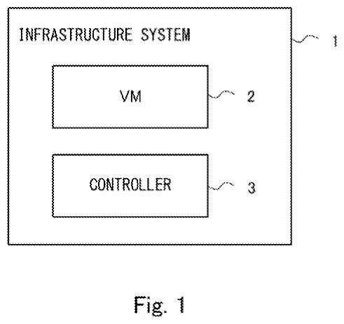

Before describing the details of an example embodiment, an outline of the example embodiment will be described. FIG. 1 is a block diagram illustrating an example of a configuration of an infrastructure system 1 according to an outline of an example embodiment. As illustrated in FIG. 1, the infrastructure system 1 includes a virtual machine (VM) 2 and a controller 3. Here, VM 2 is a VM in which a resource for executing a container including a plurality of virtual network interface cards (NIC) is implemented, and is a VM including a plurality of virtual NICs connected to different logical networks. In addition, the controller 3 controls so that a communication path in which each of the plurality of virtual NICs of the VM 2 is connected to any one of the virtual NICs of the container is configured.

In the infrastructure system 1 having the above configuration, the container operating on the VM 2 can selectively use the logical network used for communication by selectively using the plurality of interfaces of the VM 2. Therefore, according to the infrastructure system 1, network separation can be realized by a novel method in an operating environment using a container.

### Details of Example Embodiments

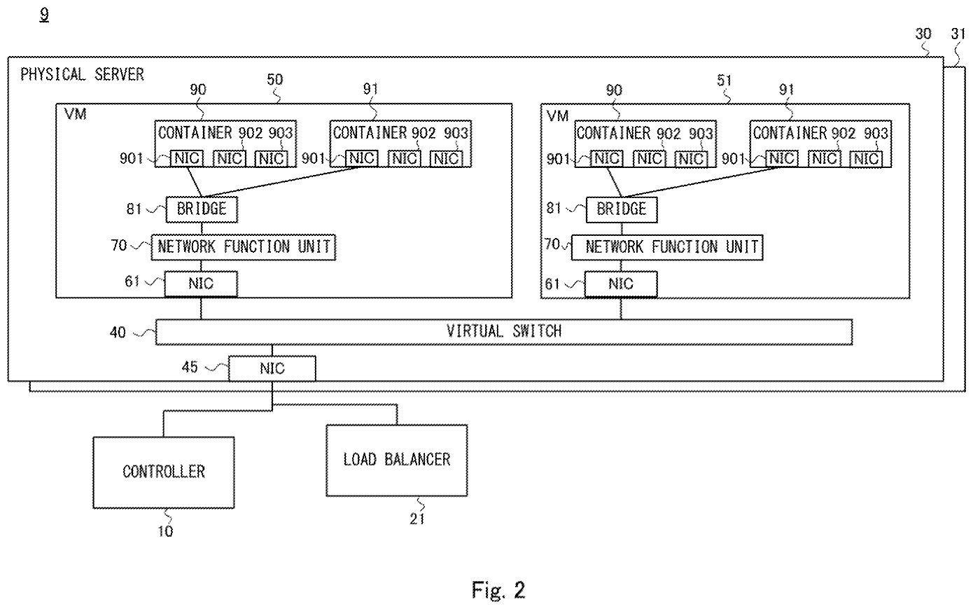

In order to help understanding of the details of the example embodiment, first, a comparative example will be described. FIG. 2 is a block diagram illustrating a configuration of an infrastructure system 9 according to a comparative example. The configuration of the infrastructure system 9 according to the comparative example is a configuration in which a Caas infrastructure is built on an infrastructure as a service (IaaS) infrastructure. The overall configuration of the infrastructure system 9 includes a controller 10, a load balancer 21 for appropriately distributing external communication, and physical servers 30 and 31 for operating containers. In the example illustrated in FIG. 2, two physical servers 30 and 31 are illustrated, but the number of the physical servers is not limited, and any number of physical servers having a similar configuration may be included. Note that the plurality of physical servers are handled as one resource as a whole by a general laaS function. Note that the number of physical servers may be one.

Since the physical server 31 has the same configuration as the physical server 30, the description of the physical server 31 will be omitted. The physical server 30 includes an NIC 45, a virtual switch 40, and VMs 50 and 51. The NIC 45 is a physical NIC, and is an interface used for communication from the physical server 30 and communication to the physical server 30. The virtual switch 40 is a virtual switch that realizes a network function of the IaaS function. That is, the virtual switch 40 is a virtual switch used for a network function provided by an laaS service. The VMs 50 and 51 are VMs that are generated by the IaaS function and actually operate the container. That is, the VMs 50 and 51 are VMs provided by IaaS services, and the containers operate on the VMs. Note that, in the example illustrated in FIG. 2, two VMs 50 and 51 are illustrated, but the number of VMs is not limited, and any number of VMs having a similar configuration may be included. Note that the number of VMs may be one.

In the example illustrated in FIG. 2, containers 90 and 91 provided by the CaaS service are operated on the VM 50. Note that the number of containers operating on each VM is arbitrary.

The controller 10 is a device that manages the container, and executes various management processes including activation of the container, setting of communication of the container, and the like. The controller 10 is a device that operates as a container orchestrator.

The load balancer 21 appropriately balances external communication across all VMs having a similar configuration including the VMs 50 and 51. Since the IaaS function treats the entire physical server as one resource, the Caas function also traverses the physical server and treats all the VMs as one resource. That is, in the CaaS service, all the VMs included in the infrastructure system 9 are treated as one resource.

Since the VM 51 has the same configuration as the VM 50, the description of the VM 51 will be omitted. In the VM 50, a virtual NIC 61, a network function unit 70, and a bridge 81 exist. The virtual NIC 61 is an NIC for connecting to each network separated by the IaaS function. That is, the VM 51 is connected to a network provided by the IaaS service via the virtual NIC 61. The network function unit 70 is a processing unit that performs relay processing of communication of the containers 90 and 91, and is used to implement container orchestration and the like. The bridge 81 is a virtual bridge that connects the containers 90 and 91 operating on the VM 50 and the network function unit 70.

The containers 90 and 91 include a virtual NIC 901, and when the containers 90 and 91 are activated, activation processing is performed so that the virtual NIC 901 of the containers 90 and 91 is connected to the bridge 81. It is also possible to add other virtual NIC (e.g., virtual NIC 902, 903 illustrated in FIG. 2) to the containers 90 and 91. However, in general, these virtual NIC are not connected to the network function unit 70 which is the CaaS function, and the user needs to build a network configuration on his/her own.

In the configuration of the comparative example illustrated in FIG. 2, in the VM 50, there is one route of communication from the container 90 (container 91) to the outside of the infrastructure system 9. Similarly, in the configuration of the comparative example illustrated in FIG. 2, in the VM 50, there is one route of communication from the outside of the infrastructure system 9 to the container 90 (container 91).

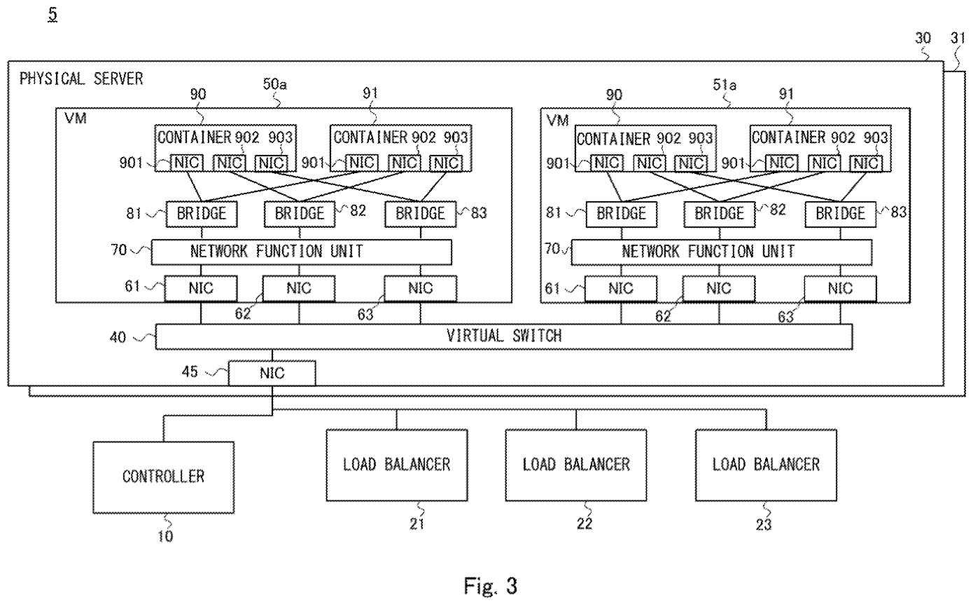

Next, the infrastructure system 5 according to the example embodiment will be described. FIG. 3 is a block diagram illustrating an example of a configuration of the infrastructure system 5 according to the example embodiment. Similarly to the infrastructure system 9, the infrastructure system 5 has a configuration in which the CaaS infrastructure is built on the IaaS infrastructure. The controller 10 of the infrastructure system 5 according to the present example embodiment corresponds to the controller 3 in FIG. 1. Therefore, the controller 10 controls so that a communication path in which each of the plurality of virtual NICs of the VM is connected to any one of the virtual NICs of the container is configured. Hereinafter, the infrastructure system 5 will be described, but the description on the same configuration and processing as those of the infrastructure system 9 will be appropriately omitted.

FIG. 3 illustrates an example of the infrastructure system 5 in a case where a total of three types of networks including a communication network between containers (a logical network 101 to be described later) and two types of external networks (logical networks 102, 103) are configured as the network. Here, two types of networks are assumed as external networks, but the number of types of external networks is not limited.

As illustrated in FIG. 3, in the infrastructure system 5, load balancers 22 and 23 are added to the infrastructure system 9 of the comparative example. Load balancers are required as many as the number of networks to be configured. Here, since three types of networks are configured as described above, the infrastructure system 5 includes three load balancers 21, 22, and 23. That is, the load balancers 21, 22, and 23 perform load distribution of different networks, respectively.

In the present example embodiment, the VMs 50 and 51 are replaced with the VMs 50a and 51a. The VMs 50a and 51a correspond to the VM 2 in FIG. 1. Therefore, the VMs 50a and 51a are VMs that provide resources for executing the container, and include a plurality of virtual NICs 61, 62, and 63 connected to different logical networks as described later. Since the VM 51a has the same configuration as the VM 50a, the description of the VM 51a will be omitted. As illustrated in FIG. 3, in the VM 50a, virtual NICs 62 and 63 are added to the VM 50 illustrated in FIG. 2, and bridges 82 and 83 corresponding to the respective virtual NICs are added. That is, the VM 50a includes a virtual NIC 61 and a bridge 81 corresponding thereto, a virtual NIC 62 and a bridge 82 corresponding thereto, and a virtual NIC 63 and a bridge 83 corresponding thereto. Each of the virtual NICs 61 to 63 and the bridges 81 to 83 has the following Internet Protocol (IP) address. That is, each pair of the virtual NIC and the bridge has IP addresses belonging to subnets different from each other. That is, the virtual NIC 61 and the bridge 81 belong to the first subnet, the virtual NIC 62 and the bridge 82 belong to the second subnet, and the virtual NIC 63 and the bridge 83 belong to the third subnet.

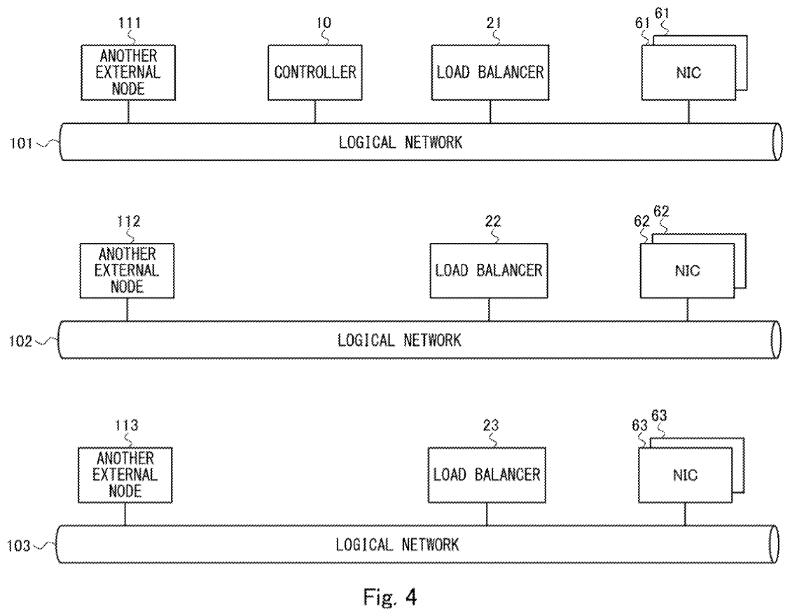

Here, in the present example embodiment, as an example, it is assumed that a logical network as illustrated in FIG. 4 is built by the laaS function. That is, the logical network as illustrated in FIG. 4 is provided by the IaaS service. Specifically, as illustrated in FIG. 4, three logical networks of logical networks 101, 102, and 103 are provided. The controller 10, the load balancer 21, and the virtual NIC 61 are connected to the logical network 101. In addition, another external node 111 is connected to the logical network 101 as necessary. As described above, the virtual NIC 61 is connected to the load balancer 21 via the logical network 101 created by the IaaS function, and is treated as one of the members under the load balancer 21. In a case where there are a plurality of VMs, the load balancer 21 appropriately performs load distribution. Furthermore, a load balancer 22 and a virtual NIC 62 are connected to the logical network 102. In addition, another external node 112 is connected to the logical network 102 as necessary. As described above, the virtual NIC 62 is connected to the load balancer 22 via the logical network 102 created by the IaaS function, and is treated as one of the members under the load balancer 22. In a case where there are a plurality of VMs, the load balancer 22 appropriately performs load distribution. Similarly, a load balancer 23 and a virtual NIC 63 are connected to the logical network 103. In addition, another external node 113 is connected to the logical network 103 as necessary. As described above, the virtual NIC 63 is connected to the load balancer 23 via the logical network 103 created by the IaaS function, and is treated as one of the members under the load balancer 23. In a case where there are a plurality of VMs, the load balancer 23 appropriately performs load distribution.

These three types of logical networks 101, 102, and 103 can be appropriately separated by the IaaS function. The separation is generally implemented by a virtual local area network (VLAN) or a virtual extensible local area network (VXLAN), but the method is not limited.

The subnet and the IP address of the bridges 81 to 83 are managed and determined by the controller 10. When the controller 10 activates the containers 90 and 91, the controller 10 causes the containers 90 and 91 to have a virtual NIC 901 to 903 connected to the bridges 81 to 83 therein, and allocates an IP address to each of the containers. Here, the virtual NIC 901 is a virtual NIC for connecting to the bridge 81, the virtual NIC 902 is a virtual NIC for connecting to the bridge 82, and the virtual NIC 903 is a virtual NIC for connecting to the bridge 83. In addition, the containers 90 and 91 are set to use the IP address of the bridge 81 as the IP address of the bridge of the default network. The network function unit 70 has a network address translation (NAT) function and a routing function, and converts a source IP address and a destination IP address according to use. At that time, the network function unit 70 performs processing in cooperation with the CaaS controller function of the controller 10 as necessary. In the case of Linux (registered trademark), the above-described process of the network function unit 70 can be implemented by, for example, iptables.

Next, with reference to the drawings, a communication method from outside the CaaS infrastructure to the container and a communication method from the container to outside the CaaS infrastructure will be described using HTTP communication generally used in the container communication as an example.

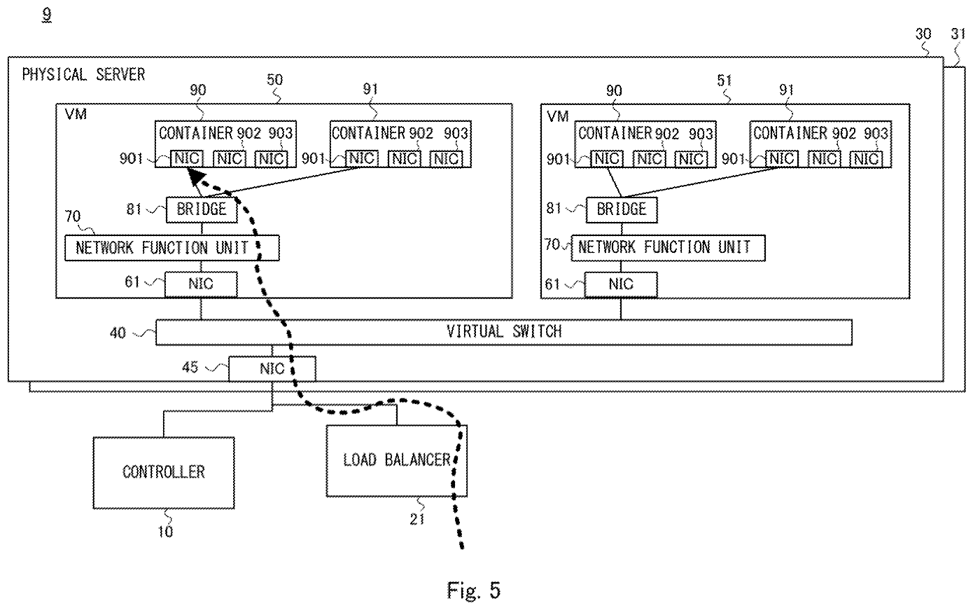

First, communication from the outside to the container will be described. FIG. 5 is a diagram illustrating a flow of communication from the outside to the container in the infrastructure system 9 according to the comparative example illustrated in FIG. 2. This flow is one of the flows of communication by the general CaaS infrastructure function, and the comparative example and the present example embodiment will be described assuming that communication is performed in such a flow. When the containers 90 and 91 are accessed from the outside, the access is performed as follows. That is, an IP address of the load balancer 21 representing the entrance of the CaaS infrastructure (infrastructure system 9) and a port number or a path name specifying a function desired to be accessed in the CaaS infrastructure (infrastructure system 9) are designated, and the access is performed. The load balancer 21 appropriately distributes a load to any VM (the VM 50 or the VM 51) for load distribution, and transfers communication to the virtual NIC 61 of any VM. Information indicating to which container the port number or the path name corresponds is given in advance from the controller 10 to the network function unit 70. The network function unit 70 converts the communication destination to the IP address of either the container 90 or 91 while considering appropriate load distribution on the container that can provide the requested service. This causes the network function unit 70 to eventually bring the communication through the bridge 81 to the container 90 or 91. Since NAT translation is used, the return communication can be appropriately returned to the source.

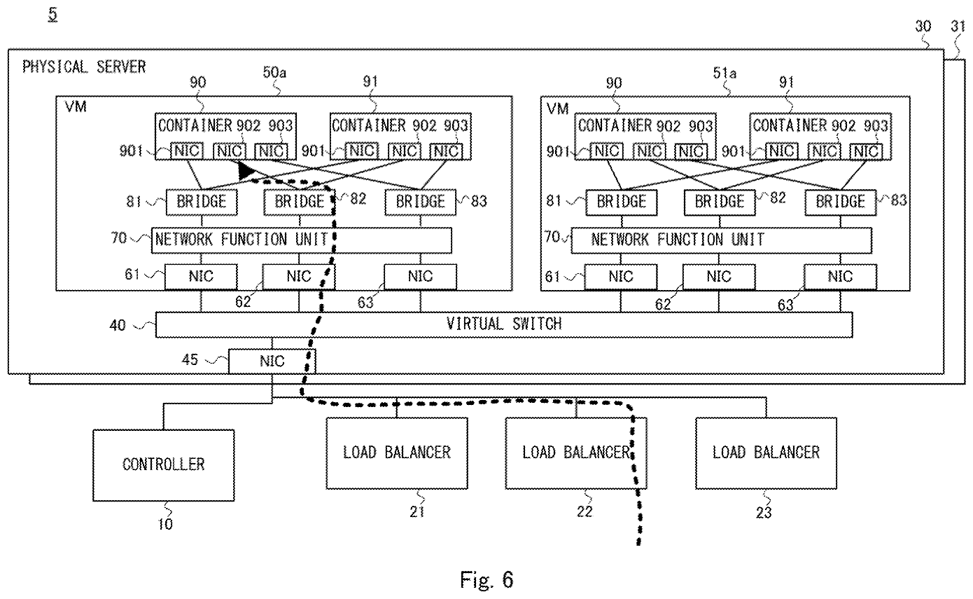

FIG. 6 is a diagram illustrating a flow of communication from the outside to the container in the infrastructure system 5 according to the example embodiment illustrated in FIG. 3. Note that, in FIG. 6, as an example, communication to the container is performed via the load balancer 22. That is, FIG. 6 illustrates a flow of communication from an access source connected to the logical network 102 illustrated in FIG. 4 to the container.

In the infrastructure system 5, communication via the load balancer 21, the virtual NIC 61, and the bridge 81 is performed in the same manner as described above with reference to FIG. 5. That is, communication from an access source connected to the logical network 101 to the container reaches the network function unit 70 through the virtual NIC 61, and is transferred to the container 90 or 91 via the bridge 81 on the basis of information set by the controller 10. At this time, the virtual NIC 901 is accessed. In the infrastructure system 5, similar operations are also performed in the communication via the load balancer 22, the virtual NIC 62, and the bridge 82. That is, communication from an access source connected to the logical network 102 to the container reaches the network function unit 70 through the virtual NIC 62, and is transferred to the container 90 or 91 via the bridge 82 on the basis of information set by the controller 10. At this time, the virtual NIC 902 is accessed. In the infrastructure system 5, similar operations are also performed in the communication via the load balancer 23, the virtual NIC 63, and the bridge 83. That is, communication from an access source connected to the logical network 103 to the container reaches the network function unit 70 through the virtual NIC 63, and is transferred to the container 90 or 91 via the bridge 83 on the basis of information set by the controller 10. At this time, the virtual NIC 903 is accessed. Therefore, in the present example embodiment, the controller 10 performs setting so that the transfer described above can be performed not only when the virtual NIC 61 receives the communication but also when the virtual NIC 62 receives the communication and when the virtual NIC 63 receives the communication. That is, the controller 10 gives the definition information of the NAT translation, that is, the information indicating the correspondence relationship between the port number or the path name and the container to the network function unit 70 in advance. The network can be separated for each function of the container by associating the function of the container provided to the outside with the network in this manner.

As described above, in the present example embodiment, the controller 10 sets NAT so that communication from the outside of the CaaS infrastructure (infrastructure system 5) to the container is transferred to the virtual NIC corresponding to the logical network used in the communication among the plurality of virtual NICs of the container. As a result, a plurality of networks can be selectively used in communication from the outside to the container.

Here, the controller 10 may be set to be inaccessible from a specific network. This can be achieved by the controller 10 not giving information for NAT translation to the network function unit 70 for a path for which access is prohibited. For example, consider a case where it is desired to disable access by communication through the load balancer 22 among accesses to the port number X. In this case, unless the controller 10 gives, to the network function unit 70, information for NAT converting communication of “destination virtual NIC 62, port number X”, the function of the port X cannot be accessed from the network to which the load balancer 22 belongs.

As described above, the controller 10 may set the NAT so that address translation is not performed for communication to a predetermined access destination among the communications from the outside of the CaaS infrastructure (infrastructure system 5) to the container. In this way, access from a specific network can be disabled.

Next, communication from the container to the outside will be described.

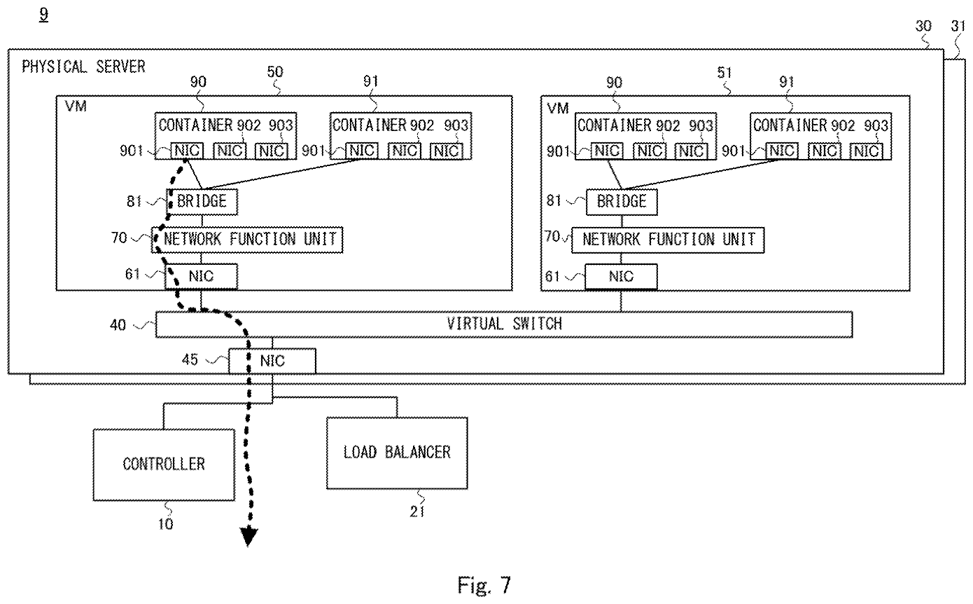

FIG. 7 is a diagram illustrating a flow of communication from the container to the outside in the infrastructure system 9 according to the comparative example illustrated in FIG. 2. This flow is one of the flows of communication by the general CaaS infrastructure function, and the comparative example and the present example embodiment will be described assuming that communication is performed in such a flow. When communication is performed from the container 90 to an IP address that does not exist outside the Caas infrastructure (the infrastructure system 9), that is, inside the CaaS infrastructure, communication is performed toward the bridge 81 that is a default gateway set to the container. Then, the source is changed to the IP address of the virtual NIC 61 by the network function unit 70, and communication is performed from the VM toward the external IP address. Since NAT translation is used, the return communication can be appropriately returned to the source.

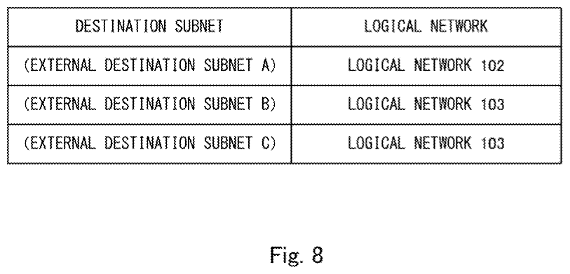

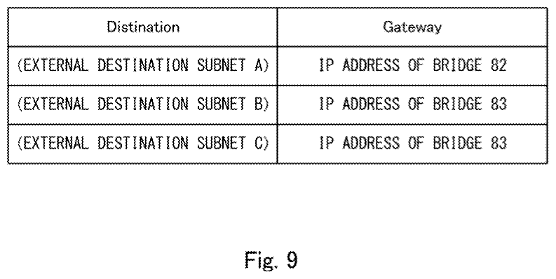

On the other hand, in the infrastructure system 5 according to the present example embodiment, the following information is registered in advance in the controller 10 in order to communicate from the container to the outside by selectively using the network. That is, information in which a destination subnet and a logical network are associated with each other is registered in advance in the controller 10. FIG. 8 is a table illustrating an example of information in which a destination subnet and a logical network are associated with each other. In the example illustrated in FIG. 8, an external destination subnet A is associated with the logical network 102, an external destination subnet B is associated with the logical network 103, and an external destination subnet C is associated with the logical network 103. The controller 10 receives the information indicating the correspondence as illustrated in FIG. 8 as an input, and the controller 10 that has received the input sets the routing table of the container so that communication exits from the bridge corresponding to the destination when activating the container. FIG. 9 illustrates an example of the routing table set by the controller 10 at the time of activating the container when the information indicating the correspondence relationship as illustrated in FIG. 8 is registered in the controller 10. In the routing table illustrated in FIG. 9, the external destination subnet A is associated with the IP address of the bridge 82. In addition, in this routing table, the external destination subnet B is associated with an IP address of the bridge 83, and the external destination subnet C is associated with an IP address of the bridge 83. Accordingly, for example, in a case where a destination in communication to the outside belongs to the subnet A, communication from the containers 90 and 91 to the destination is transferred to the network function unit 70 via the virtual NIC 902 and the bridge 82. The following settings are made in the network function unit 70 by the controller 10. That is, the network function unit 70 is set to convert the source into the IP address of the virtual NIC (i.e., any one of the virtual NICs 61, 62, or 63) corresponding to the bridge according to the subnet of the bridge of the source. In the example described in the present example embodiment, the subnet of the bridge 81 is set to be converted into the IP address of the virtual NIC 61, the subnet of the bridge 82 is set to be converted into the IP address of the virtual NIC 62, and the subnet of the bridge 83 is set to be converted into the IP address of the virtual NIC 63.

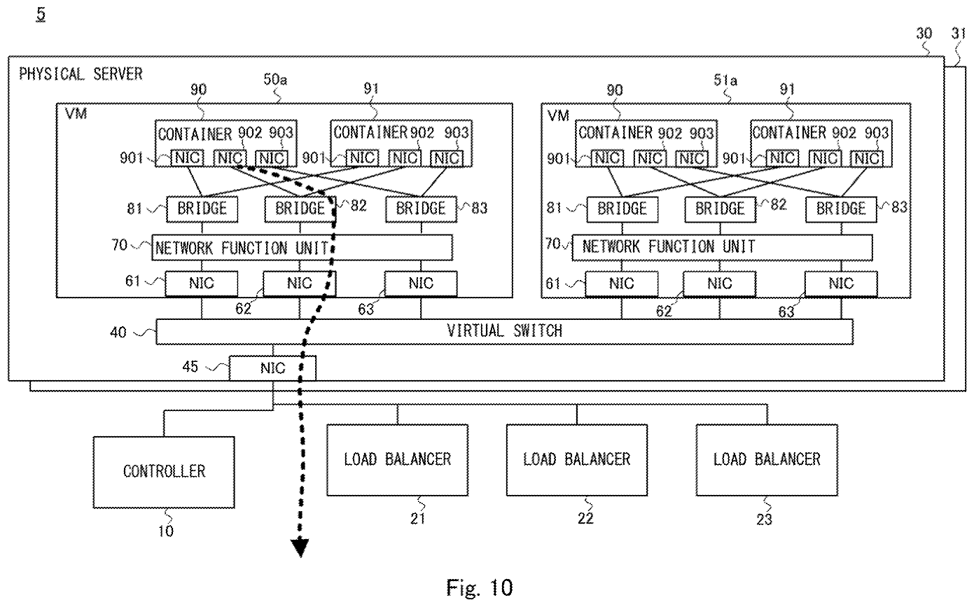

FIG. 10 is a diagram illustrating a flow of communication from the container to the outside in the infrastructure system 5 according to the example embodiment illustrated in FIG. 3. Note that FIG. 10 illustrates, as an example, a flow of communication to the outside through a network connected to the virtual NIC 62. As described above, since routing setting is performed in advance, the container 90 communicates toward the bridge 82. At this time, the network function unit 70 changes the source to the IP address of the virtual NIC 62, and performs communication from the VM toward the external IP address.

As described above, in the present example embodiment, the controller 10 sets routing so as to use a logical network corresponding to an access destination for communication from the container to the outside of the CaaS infrastructure (infrastructure system 5). Then, the controller 10 performs NAT setting so that the source of the communication from the container to the outside becomes the address of the virtual NIC connected to the logical network used for the relevant communication among the plurality of virtual NICs of the VM. As a result, a plurality of networks can be selectively used in communication from the container to the outside.

Here, the controller 10 may set the container not to be connected to an external network. Specifically, when the controller 10 sets the network function unit 70 so as not to NAT the communication from a specific bridge at the time of generating the container, it is possible not to connect the container to the external network. For example, in a case where it is not desired to connect a specific container to a network connected to the virtual NIC 62, when the IP address of the container is the source, the access is dropped without being converted, so that the container cannot perform the communication from the virtual NIC 62.

As described above, the controller 10 may set the NAT so that address translation is not performed for communication of a predetermined source among the communications from the container to the outside of the CaaS infrastructure (infrastructure system 5). This makes it possible to restrict communication from the container to the outside.

The example embodiment has been described above. In the infrastructure system 5 having the above configuration, the container operating on the VM can selectively use the logical network to use for communication by selectively using the plurality of interfaces of the VM.

In particular, according to the infrastructure system 5, network separation according to use can be realized while maintaining the scalability and flexibility realized by the CaaS infrastructure. As a result, external communication is appropriately separated, and performance management or the like using a header used for separation can also be realized. For example, by passing important communication through one logical network and maximizing the priority of the logical network by the operation of the layer in the IaaS, it becomes possible to preferentially pass only some communications. The reason therefor is that an interface for communication of the container is connected to a network provided by the IaaS while maintaining the scalability and flexibility of the container by a function of container orchestration which is an existing technology. In addition, according to the infrastructure system 5, the separated network can be associated with the container and the container implementing function connectable to the network can be managed for each network. The reason therefor is that by providing a virtual NIC of the VM used for communication from the outside to the CaaS infrastructure and a bridge used for communication from the container to the outside for each network, access management based on the IP addresses can be performed.

Note that the above-described functions (processes) of the physical servers 30 and 31, the controller 10, or the load balancers 21, 22, and 23 may be realized by, for example, the computer 500 having the following configuration.

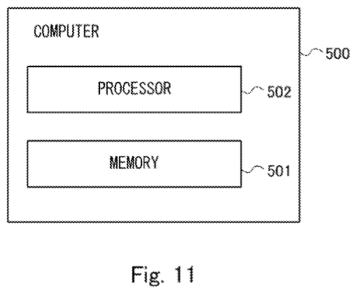

FIG. 11 is a block diagram illustrating a configuration of a computer 500 that realizes processes of the physical servers 30 and 31, the controller 10, or the load balancers 21, 22, and 23 as an example. As illustrated in FIG. 11, the computer 500 includes a memory 501, and a processor 502.

The memory 501 includes, for example, a combination of a volatile memory and a nonvolatile memory. The memory 501 is used to store software (computer program) including one or more instructions executed by the processor 502, and the like.

The processor 502 reads the software (computer program) from the memory 501 and executes the same to perform processes of the physical servers 30 and 31, the controller 10, or the load balancers 21, 22, and 23.

The processor 502 may be, for example, a microprocessor, a microprocessor unit (MPU), or a central processing unit (CPU). The processor 502 may include a plurality of processors.

In addition, the program described above may be stored by using various types of non-transitory computer readable medium to be supplied to a computer. The non-transitory computer-readable medium includes various types of tangible storage medium. Examples of non-transitory computer-readable medium include a magnetic recording medium (for example, a flexible disk, a magnetic tape, or a hard disk drive), a magneto-optical recording medium (for example, a magneto-optical disk), a CD-read only memory (ROM) CD-R, a CD-R/W, and a semiconductor memory (for example, a mask ROM, a programmable ROM (PROM), an erasable PROM (EPROM), a flash ROM, and a random access memory (RAM)). In addition, the program may be supplied to a computer through various types of transitory computer readable medium. Examples of the transitory computer-readable medium include electrical signals, optical signals, and electromagnetic waves. The transitory computer-readable medium can provide the program to the computer via a wired communication line such as an electric wire and optical fibers or a wireless communication line.

Although the present invention has been described above with reference to the example embodiments, the present invention is not limited to the above. Various modifications that can be understood by those skilled in the art can be made to the configuration and details of the present invention within the scope of the present invention.

Some or all of the above example embodiments may be described as the following Supplementary notes, but are not limited to the following.

### Supplementary Note 1

An infrastructure system including,
a virtual machine (VM) in which a resource for executing a container including a plurality of virtual network interface cards (NIC) is implemented and which includes a plurality of virtual NICs connected to different logical networks: and
a controller configured to control so that a communication path in which each of a plurality of the virtual NICs of the VM is connected to any one of the virtual NICs of the container is configured.

### Supplementary Note 2

The infrastructure system described in Supplementary note 1, where the controller sets a network address translation (NAT) such that communication from the outside of the infrastructure system to the container is transferred to the virtual NIC corresponding to the logical network used in the communication among the plurality of virtual NICs of the container.

### Supplementary Note 3

The infrastructure system described in Supplementary note 2, where the controller sets the NAT so that address translation is not performed for communication to a predetermined access destination among communications from the outside of the infrastructure system to the container.

### Supplementary Note 4

The infrastructure system described in Supplementary note 1, where the controller is configured to,
set routing so as to use the logical network corresponding to an access destination for communication from the container to the outside of the infrastructure system: and
set NAT so that a source of communication from the container to the outside of the infrastructure system becomes an address of the virtual NIC connected to the logical network used for the communication among the plurality of virtual NICs of the VM.

### Supplementary Note 5

The infrastructure system described in Supplementary note 4, where the controller sets the NAT so that address translation is not performed for communication of a predetermined source among communications from the container to the outside of the infrastructure system.

### Supplementary Note 6

A communication method including the steps of,
having a VM including a plurality of virtual NICs connected to different logical networks execute a container including a plurality of virtual NICs: and
having a controller control so that a communication path in which each of a plurality of the virtual NICs of the VM is connected to any one of the virtual NICs of the container is configured.

### REFERENCE SIGNS LIST

1 INFRASTRUCTURE SYSTEM
2 VM
3 CONTROLLER
5 INFRASTRUCTURE SYSTEM
9 INFRASTRUCTURE SYSTEM
10 CONTROLLER
21 LOAD BALANCER
22 LOAD BALANCER
23 LOAD BALANCER
30 PHYSICAL SERVER
31 PHYSICAL SERVER
40 VIRTUAL SWITCH
61 VIRTUAL NIC
62 VIRTUAL NIC
63 VIRTUAL NIC
70 NETWORK FUNCTION UNIT
81 BRIDGE
82 BRIDGE
83 BRIDGE
90 CONTAINER
91 CONTAINER
101 LOGICAL NETWORK
102 LOGICAL NETWORK
103 LOGICAL NETWORK
111 NODE
112 NODE
113 NODE
500 COMPUTER
50 MEMORY
502 PROCESSOR
901 VIRTUAL NIC
902 VIRTUAL NIC
903 VIRTUAL NIC

What is claimed is:

1. An infrastructure system comprising:
a virtual machine (VM) in which a resource for executing a container including a plurality of virtual network interface cards (NIC) is implemented and which includes a plurality of virtual NICs connected to different logical networks;
at least one memory storing instructions; and
at least one processor configured to execute the instructions to control so that a communication path in which each of a plurality of the virtual NICs of the VM is connected to any one of the virtual NICs of the container is configured.

2. The infrastructure system according to claim 1, wherein the processor is further configured to execute the instructions to set a network address translation (NAT) such that communication from the outside of the infrastructure system to the container is transferred to the virtual NIC corresponding to the logical network used in the communication among the plurality of virtual NICs of the container.

3. The infrastructure system according to claim 2, wherein the processor is further configured to execute the instructions to set the NAT so that address translation is not performed for communication to a predetermined access destination among communications from the outside of the infrastructure system to the container.

4. The infrastructure system according to claim 1, wherein the processor is further configured to execute the instructions to:
set routing so as to use the logical network corresponding to an access destination for communication from the container to the outside of the infrastructure system; and
set NAT so that a source of communication from the container to the outside of the infrastructure system becomes an address of the virtual NIC connected to the logical network used for the communication among the plurality of virtual NICs of the VM.

5. The infrastructure system according to claim 4, wherein the processor is further configured to execute the instructions to set the NAT so that address translation is not performed for communication of a predetermined source among communications from the container to the outside of the infrastructure system.

6. A communication method comprising the steps of:
having a VM including a plurality of virtual NICs connected to different logical networks execute a container including a plurality of virtual NICs; and
having a controller control so that a communication path in which each of a plurality of the virtual NICs of the VM is connected to any one of the virtual NICs of the container is configured.
